(19) United States
(12) Patent Application Publication
(10) Pub. No.: US 2024/0266635 A1
(43) Pub. Date: Aug. 8, 2024

(54) CELL COOLING UNIT FOR MULTI-SIDED COOLING OF A PRISMATIC BATTERY CELL, COOLING ARRANGEMENT AND BATTERY MODULE FOR A MOTOR VEHICLE

(71) Applicant: AUDI AG, Ingolstadt (DE)

(72) Inventors: Carsten LORENZ, Reichertshofen (DE); Eduard MAIN, Buxheim (DE)

(73) Assignee: AUDI AG, Ingolstadt (DE)

(21) Appl. No.: 18/394,087

(22) Filed: Dec. 22, 2023

(30) Foreign Application Priority Data
Feb. 3, 2023 (DE) 102023102715.8

(51) Int. Cl. H01M 10/6556; H01M 10/613; H01M 10/625; H01M 10/647; H01M 50/209; H01M 50/342

(52) U.S. Cl. CPC H01M 10/6556; H01M 10/613; H01M 10/625; H01M 10/647; H01M 50/209; H01M 50/3425; H01M 2220/20

(57) ABSTRACT

A cell cooling unit for multi-sided cooling of a prismatic battery cell of a battery module. The cell cooling unit has a first cooling wall for arrangement on a first side of the prismatic battery cell and a second cooling wall for arrangement on a second side of the battery cell. The second cooling wall connects at right angles to the first cooling wall. The first cooling wall has at least one first cooling channel portion through which a liquid coolant can flow, and the second cooling wall has at least one second cooling channel portion through which a liquid coolant can flow.

### FIELD

The invention relates to a cell cooling unit for multi-sided cooling of a prismatic battery cell of a battery module, wherein the cell cooling unit has a first cooling wall for arrangement on a first side of the prismatic battery cell and a second cooling wall for arrangement on a second side of the battery cell, wherein the second cooling wall connects at right angles to the first cooling wall. Furthermore, the invention also relates to a cooling arrangement and a battery module for a motor vehicle.

### BACKGROUND

High-voltage batteries for motor vehicles often have multiple battery modules, each with multiple battery cells. In order to cool the battery cells, such high-voltage batteries typically also comprise a cooling device. These cooling devices are often designed as simple cooling plates on which the battery modules are placed. The battery cells of a battery module are often arranged next to one another in a stacking direction, wherein a cell separating element for thermal decoupling of the cells and for swelling compensation is located between two adjacent battery cells, for example. Based on previous cooling concepts, such a cooling plate is often only connected to a small surface area of such a battery cell. In particular, often only one side of such a battery cell or the two opposite sides of a battery cell, for example a top and a bottom side, can be cooled. The largest sides of a prismatic battery cell in terms of region are typically those sides that face the neighboring cells in a cell stack. These sides are often not connected to a cooling system.

U.S. Pat. No. 10,811,744 B2 describes a battery cell with a film cover for electrochemically active material, wherein the film cover has an essentially prismatic form, and with current collectors that electrically contact the electrochemically active material and serve to interconnect the battery cells. A current collector has a flat element that essentially covers a main surface of the film cover and a connection region for thermal connection to a cooling device or is provided with cooling channels through which air can flow. For connection to a cooling device, the connection region of the current conductor at least partially covers at least one secondary surface of the film cover. The connection region for connecting to the cooling device can protrude beyond the battery cell. In this case, the current collectors are purely passive cooling elements, which, for example, are not themselves flowed through by a cooling medium, but are only cooled indirectly via the mechanical connection to the cooling device. In a further embodiment, the flat element of the current collector can be provided with cooling channels that are open on both sides and allow air to flow therethrough.

Purely passive cooling, for example through a purely solid cooling plate, substantially always provides less cooling performance than with active cooling, in which a cooling medium flows through a cooling plate. Although air as a cooling medium has the advantage that it can also flow through components through which current flows, such as current collectors, due to its electrically insulating properties, the problem that arises when using air as a cooling medium is that air has a significantly lower heat capacity than typical cooling liquids, such as water, thus resulting in lower cooling efficiency. In addition, the provision of cooling channels in a cell stack in a region between two battery cells has the disadvantage that it requires significantly more space between the cells than, for example, just a simple plate without cooling channels. Reducing the size of the cooling channels in order to reduce the required installation space between the cells, especially in combination with air cooling, has the disadvantage that the already lower cooling efficiency is reduced even further.

Furthermore, DE 10 2017 005 315 A1 describes a battery box for accommodating battery modules. The battery box includes multiple L-shaped housing elements that can be connected to one another in a form-fitting manner and thus provide receiving regions for the individual battery modules. Cooling channels can also be integrated into these L-shaped elements.

Although multiple sides of a battery cell can thus also be simultaneously cooled, these are the smaller end faces of a battery cell. This means that cooling between the battery cells cannot be implemented.

### SUMMARY

The object of the present invention is therefore to provide a cell cooling unit, a cooling arrangement and a battery module that allow the most cost-effective, space-efficient and high performing cooling of prismatic battery cells.

A cell cooling unit for multi-sided cooling of a prismatic battery cell of a battery module according to the invention comprises a first cooling wall for arrangement on a first side of the prismatic battery cell and a second cooling wall for arrangement on a second side of the battery cell, wherein the second cooling wall connects at right angles to the first cooling wall. The first cooling wall has at least one first cooling channel portion through which a liquid coolant can flow, and the second cooling wall has at least one second cooling channel portion through which a liquid coolant can flow.

This means that the cell cooling unit can advantageously provide a cooling device through which a liquid flows for multi-sided cooling of a prismatic battery cell, which cooling device can also be used in particular on the sides of a prismatic battery cell having the largest surface area and this in a space-saving manner, since even a small wall thickness of the cooling walls can still provide for very high performing cooling due to the possibility of using a liquid coolant. Liquid cooling is significantly more efficient than, for example, gas cooling or even purely passive cooling. The invention is also based on the knowledge that liquid cooling, that is, the flow of liquid through the cooling walls, is particularly cost-effective if the cell cooling unit is not also designed as a current-carrying component in normal operation, such as a current collector. In other words, the cell cooling unit according to the invention is not intended for electrical contacting of a cell pole of the battery cell. The cell cooling unit is therefore different from a current collector or other current-carrying component. The cell cooling unit therefore does not assume a dual function, at least not a current-carrying function, which means that the cooling function provided by the cell cooling unit can be optimized. The liquid coolant that flows through the first and/or second cooling wall can therefore be, for example, simply water or a water-based coolant, for example water with additives, or in general any liquid coolant, in particular also an electrically conductive coolant. This enables a cost-effective design, because an inexpensive coolant such as water can be used and, above all, the cooling circuit in which the cell cooling unit is integrated in its intended use in the motor vehicle can be coupled to the conventional existing cooling circuit of the motor vehicle or be part of it and use the same coolant, and the same coolant reservoir, for example, wherein, although less preferably, the cell cooling unit can also be used to provide gas cooling.

Due to the angled design of the cell cooling unit, at least two sides of the prismatic battery cell can be cooled at the same time. One of the two sides preferably represents one of the two largest sides of the battery cell in terms of surface area. In particular, one of the two sides, in particular the first side of the prismatic battery cell, should represent the one that faces another battery cell arranged adjacently, when the battery cell is used as intended in a battery module. This has the great advantage that the first cooling wall cannot just be used to cool the first side of the prismatic battery cell, but also to cool another side of the battery cell arranged adjacently in the cell stack. This makes cooling even more efficient and further installation space can be saved. If one considers a battery module with multiple battery cells and respective associated cell cooling units, it can be achieved that each battery cell is cooled directly from at least three sides, namely through direct contact with a corresponding cooling wall of a cell cooling unit, of which two of these two sides of the battery cell also represent the two largest sides of the battery cells in terms of surface area. This ultimately allows the cooling efficiency of cooling the battery cells to be maximized.

A cell cooling unit should be understood to mean a cooling unit that is used at the cell level and not at the module level, and which is assigned to a battery cell, for example, in particular which can only be assigned to a single battery cell. In a battery module, in particular a cell stack with multiple battery cells, the largest sides of which, in terms of surface area, face each other, multiple such cell cooling units are preferably provided, for example one per battery cell of such a cell stack, when viewed in the stacking direction. In the intended arrangement of the corresponding cell cooling units on the associated battery cells, a first cooling wall is located between two battery cells arranged next to one another in such a stacking direction. The first cooling wall of a respective cell cooling unit can therefore be located, for example, at the position at which cell separating elements are normally located between the battery cells. This can also be dispensed with, since the cell cooling unit and in particular its first cooling wall can simultaneously provide a thermal barrier in the event of a battery cell thermal runaway, as well as a certain flexibility and reactive force to compensate for swelling. In the direction of a cell stack, the provision of these cell cooling units thus means that the required installation space is the same as in previous conventional modules. In addition, additional components can be saved and the cooling of a respective battery cell can be enormously improved.

The fact that the first cooling wall has at least one first cooling channel portion through which a liquid coolant can flow is preferably to be understood as meaning that such a first cooling channel portion does not open into a surrounding area. The cooling channel portions are thus integrated into the cooling walls or the cell cooling unit and its cooling walls are designed in such a way that a liquid coolant supplied to the cell cooling unit, in particular a liquid coolant supplied to the first cooling wall, does not leak out of the cell cooling unit into its surroundings, but can be discharged again in a controlled manner, for example via a line provided for this purpose, which can be connected to the cell cooling unit. A coolant can therefore be circulated in a closed cooling circuit through the cell cooling unit and its cooling walls. As explained in more detail later, the cell cooling unit can also have a supply connection and a discharge connection for coolant supply and coolant discharge. A coolant can therefore be supplied to the cell cooling unit via these connections, this coolant can then be guided through the first and/or second cooling channel portion and discharged again from the discharge connection without the coolant being able to escape from the cooling circuit and get into the surrounding area. The first cooling channel portion, and in a corresponding manner also the second cooling channel portion in the second cooling wall, thus have or provide just interfaces for connection to a cooling circuit, but have otherwise no interfaces or outlet points into the surrounding area. Thus liquid coolant leaking can be prevented.

The prismatic battery cell is preferably a battery cell with a cell housing that is not designed as a pouch. The battery cell is therefore preferably not a prismatic shaped pouch cell. The cell housing of the prismatic cell is preferably designed to be structurally rigid. The battery cell can be formed, for example, as a lithium-ion cell.

In a further advantageous embodiment of the invention, the at least one first cooling channel portion and the at least one second cooling channel portion are fluidly connected to one another. This has the great advantage that the number of required inlet and outlet connections for the cell cooling unit can be minimized. For example, a liquid coolant can be supplied to the first cooling channel portion of the first cooling wall, and this coolant can accordingly be supplied via this first cooling channel portion to the second cooling channel portion of the second cooling wall, pass through it and, for example, be guided back into the first cooling wall, for example into a further first cooling channel portion connected to the second cooling channel portion within the first cooling wall. Depending on the provision and positioning of the supply and discharge connections, the coolant can also be supplied to the second cooling wall and thus first pass through the second cooling channel portion, then be introduced into the first cooling wall and accordingly into the first cooling channel portion, pass through this and be guided back into the second cooling wall, and pass through a further second cooling channel portion located therein. In principle, the first cooling channel portion and the second cooling channel portion can be viewed as respective portions of an overall cooling channel, which passes through at least the first and second cooling wall. Such an overall cooling channel can also include numerous further first and/or second portions in the form of further first and/or second cooling channels, and in particular also one or more third cooling channel portions of an optional further third cooling wall, which will be described later. There are generally no limits to the design of the channel routing within the first and/or second cooling wall.

The cell cooling unit can generally comprise two wall elements, for example metal sheets, which are connected to one another, preferably by means of a roll bonding process, or also by means of welding and/or soldering or less preferably by means of gluing, so that an intermediate space providing the cooling channels is formed between these wall elements. These two interconnected wall elements can then be brought into the angled shape described so that the second cooling wall connects to the first cooling wall at a right angle. It is also conceivable to initially provide wall elements that are designed at right angles and then connect them to one another to form the cooling channels. The already cited joining methods can also be used in this case. Above all, the use of a roll bonding process has proven to be particularly advantageous in terms of the stability and tightness of the connection between the individual wall elements provided thereby. Therefore, the provision of the cell cooling unit using the roll bonding process is preferred, as this can increase the leakage resistance of the cell cooling unit, its stability and thus safety in general.

Another major advantage of this angled design of the cell cooling unit is that, for example in the event of a crash, significantly higher forces can be absorbed than, for example, flat plates that are not angled. This offers additional protection for the battery cell arranged on the cell cooling unit. By having the cell cooling unit protrude laterally beyond such a battery cell, it is also possible to direct forces impinging on the cell cooling unit through it without the battery cell itself being subjected to force, or at least such force can be reduced to a minimum. This is particularly advantageous if the cell poles are arranged laterally on the battery cell, as will be explained in more detail later.

In a further very advantageous embodiment of the invention, the cell cooling unit has a third cooling wall for arrangement on a third side of the battery cell, wherein the third cooling wall connects to the first cooling wall at a right angle and lies opposite the second cooling wall, in particular wherein the third cooling wall has at least a third cooling channel portion, which is fluidly connected to the first cooling channel portion. In this example, the cell cooling unit can thus be U-shaped, which advantageously enables the cooling of an additional side of the battery cell. The cell cooling unit itself can therefore cool three sides of this assigned prismatic battery cell through direct contact, while when properly arranged in a cell stack, another side of the battery cell can also be cooled by the cell cooling unit assigned to the adjacent battery cell. Overall, this design of the cell cooling unit when used in a cell stack allows the provision of four sides of such a prismatic battery cell with cooling through direct contact with a corresponding cooling wall of a cell cooling unit through which a liquid coolant can flow and actually flows during normal operation.

However, it is also conceivable that the cell cooling unit only has the first cooling wall and the second cooling wall as the only cooling walls, and is therefore L-shaped in terms of its geometry. The sides of a battery cell that are not directly adjacent to a cooling wall of the cell cooling unit can be cooled, for example, by arranging this cell assembly or the cell stack formed with the respective cell cooling units on a cooling plate.

The U-shaped design of the cell cooling unit has the advantage that there is no need to provide such an additional cooling plate. This allows a simplified design, for example of a common battery housing, in which multiple such battery modules can be arranged.

In a further advantageous embodiment of the invention, the second cooling wall has a recess for a cell degassing opening of the battery cell. In order to enable controlled degassing of such a battery cell in the event of a battery cell thermal runaway, battery cells, at least typical prismatic battery cells, have a releasable degassing opening. This opens preferably passively in the event of excess pressure within the battery cell, and is designed, for example, as a predetermined breaking point, for example as a bursting membrane, or as an overpressure valve, or similar. It is advantageous if, in such a cell degassing case, gas can escape unhindered from the cell, in particular from this cell degassing opening, and this is not blocked or closed by other components or elements. Accordingly, it is very advantageous if one of the cooling walls of the cell cooling unit, in the present case the second cooling wall, alternatively also the optional third cooling wall, has a corresponding recess for such a cell degassing opening. This makes it advantageously possible to efficiently cool even that side of the battery cell on which such a cell degassing opening is located. At the same time, the recess can ensure an unhindered gas exit from the cell degassing opening in the event of a thermal runaway of the battery cell.

In principle, this recess can take on various forms. In general, it should be designed in such a way that, when the cell cooling unit is arranged as intended on the associated battery cell, the cell degassing opening of the battery cell is not covered or overlapped by the second cooling wall or alternatively by the third cooling wall, if provided with the recess for the cell degassing opening. Furthermore, the descriptions of the recess, which are provided with reference to the second cooling wall, also apply in an analogous manner to the third cooling wall if this includes the recess instead of the second cooling wall. For example, at a corresponding point in the second cooling wall, a hole or a through opening can be provided therein to provide the recess, which corresponds, for example, to the geometry of the cell degassing opening provided on the battery cell.

However, it is particularly advantageous, as provided in a further embodiment of the invention, if the second cooling wall has a wall width in a first direction and a wall length in a second direction, wherein the wall width varies along the second direction and is smaller in the region of the recess for the cell degassing opening with respect to a maximum wall width of the second cooling wall in the first direction. The edge-side contour of the second cooling wall thus does not run in a straight line, but rather, for example, in a meandering manner or has a notch, for example an undulating or rectangular notch or depression in the direction of the first cooling wall. This simplifies the production of the cell cooling unit in contrast to providing a hole in the second cooling wall, and is also more stable. This is primarily due to the fact that the maximum wall width of the second cooling wall essentially corresponds to the width of the battery cell in the first direction, which also represents the smallest dimension of the prismatic battery cell. By indenting the second cooling wall instead of providing a breakthrough, a remaining thin and therefore possibly only slightly stable connecting web can be avoided.

The sides of the cooling walls that are to be brought into contact with the associated battery cell are preferably flat or at least mostly flat. In addition, it is preferred that both opposite sides of the first cooling wall are at least mostly flat, since the first cooling wall should be positioned between two cells and should accordingly be brought into contact with both cells as flatly as possible. In the case of the second and the optional third cooling wall, however, it is sufficient if the sides of the cooling walls facing the battery cell are flat or at least mostly flat.

According to a further advantageous embodiment of the invention, the cell cooling unit has a coolant supply connection and a coolant discharge connection, which are arranged on the second and/or third cooling wall. In particular, it is possible that both the coolant supply connection and the coolant discharge connection are both arranged on the second cooling wall or both arranged on the third cooling wall, or that one of the two connections is arranged on the second cooling wall and the other of the two connections is arranged on the third cooling wall. Preferably, none of the connections is arranged on the first cooling wall. The reason for this is that the first cooling wall is preferably positioned between two battery cells when arranged as intended in a cell stack. At least a position on the regions of the first cooling wall facing the corresponding sides of the battery cells is then unfavorable for providing such connections. A lateral arrangement in an edge region of the first cooling wall, which protrudes slightly from an intermediate space between two battery cells, might be conceivable.

Furthermore, it is preferred if each cell cooling unit has only one single coolant supply connection and one single coolant discharge connection. The cooling walls of the cell cooling unit, and more precisely the cooling channel portions integrated into the cooling walls, are therefore preferably all fluidly connected to one another, so that the liquid coolant supplied via the coolant supply connection flows through all cooling walls encompassed by the cell cooling unit before it is discharged again from the coolant discharge connection becomes. The coolant supply connection therefore can be or is coupled to a coolant supply line of a cooling circuit of the motor vehicle in which the cell cooling unit is used, and accordingly the coolant discharge connection can be coupled or is coupled during operation to a corresponding coolant discharge line of this cooling circuit. The cell cooling unit can be connected to a cooling circuit via these connections. This provides in particular a closed cooling circuit. For the purpose of cooling or temperature control of the battery cells, the coolant, in particular the liquid coolant, circulates in this cooling circuit. To convey the coolant, the cooling circuit can have corresponding pumps.

Furthermore, it is preferred that the supply and discharge connections are positioned at the bottom in relation to an intended installation position of the cooling arrangement or the cell cooling unit in a motor vehicle, that is to say on the lower of the two walls consisting in the second cooling wall and the third cooling wall. This has the advantage that in the event of a leak in the region of these connections, the escaping coolant cannot come into contact with the battery cells. The supply and discharge connections are preferably located on the cooling wall of the cell cooling unit that also has the recess for the cell degassing opening.

Furthermore, the invention also relates to a cooling arrangement with a cell cooling unit according to the invention or one of its embodiments. The advantages mentioned for the cell cooling unit according to the invention and its embodiments thus apply equally to the cooling arrangement according to the invention.

In a further advantageous embodiment, the cooling arrangement comprises the prismatic battery cell. This can generally be designed as previously described in connection with the cell cooling unit. The battery cell in particular has a cell width in a first direction, a cell length in a second direction and a cell height in a third direction, wherein the prismatic battery cell also has the first side and an opposite fourth side which delimit the battery cell in the first direction and which represent the two largest sides of the battery cell in terms of surface area, wherein the battery cell has a fifth side and an opposite sixth side which delimit the battery cell with respect to the second direction, and wherein the battery cell has the second and third sides which delimit the battery cell with respect to the third direction. It is further preferred that the maximum wall width of the second cooling wall and/or the third cooling wall corresponds to the cell width or is smaller.

It is therefore provided that the first cooling wall rests on one of the two largest sides of the prismatic battery cell, in terms of surface area, namely the first side of the battery cell in this case. In a cell stack with multiple such battery cells and associated cell cooling units, the first cooling wall of the cell cooling unit, which is associated with the adjacent battery cell, then rests on the fourth side of the battery cell, which also represents one of the two largest sides of the battery cell. Through the design of the cell cooling units described above, it can advantageously be achieved that with minimal effort the two largest sides of a respective battery cell, in terms of surface area, can be efficiently cooled by liquid cooling, namely by direct contact with a first cooling wall of such a cell cooling unit, through which a liquid coolant flows during operation. In addition, other sides of the battery cell can also be cooled, in particular at least one and/or two additional sides, so that the cooling effect can be further increased.

According to a further very advantageous embodiment of the invention, the battery cell has two cell poles which are arranged on the fifth and/or sixth side of the battery cell, in particular one of which is arranged on the fifth side and one on the sixth side. The fifth and sixth sides of the battery cell represent the sides on which no cooling wall of a cell cooling unit rests. Accordingly, there is enough installation space there to provide the cell poles and to provide a corresponding electrical interconnection of the cell poles to one another, for example via cell connectors or similar. In addition, in this case, the cell poles and the cell degassing opening described above, which is preferably arranged on the second and/or third side of the battery cell, are arranged on different sides of the battery cell. This makes it even more efficient to prevent any gas escaping from the battery cell from coming into contact with the cell poles. This also makes gas removal much easier. Especially in combination with the cell cooling unit described, maximum cooling of such a prismatic battery cell can thus be provided.

In a further very advantageous embodiment of the invention, the first cooling wall protrudes in the second direction at least beyond one of the fifth and sixth side of the battery cell. This is particularly advantageous if the cell poles of the battery cell are arranged on the fifth and sixth side as described above. If there is an external force acting on the battery or on a battery module in and/or against the second direction, the first cooling wall protruding in this direction beyond the fifth and/or sixth side can prevent a force from acting directly on the cell poles. In this case, the force will first act on the first cooling wall and can, for example, be transmitted through this to the opposite side of the cooling arrangement. This can provide maximum protection for the battery cells and in particular the cell poles. The crash safety of the cooling arrangement including the battery cells can thus be significantly increased. In addition, due to the L-shaped and in particular the U-shaped structure of the cell cooling unit, the stability and force absorption capacity in the event of such a force is very high.

In a further very advantageous embodiment of the invention, the battery cell has a releasable cell degassing opening on the second side or on the third side, in particular in the form of a predetermined breaking point, for example a bursting membrane. It can also be configured as described above. This cell degassing opening can then, for example, point upwards or downwards in relation to the intended installation position of the cooling arrangement in a motor vehicle. The downward orientation is preferred since the gas can then be discharged accordingly downwards and away from a passenger compartment of the motor vehicle.

Furthermore, the invention also relates to a battery module for a motor vehicle, with a plurality of prismatic battery cells which are arranged next to one another in the first direction, wherein each of the battery cells is assigned a cell cooling unit according to the invention or one of its embodiments, which is arranged on an assigned battery cell, so that the first cooling wall of at least one of the cell cooling units is located between battery cells arranged adjacent to one another and in particular rests on both of these battery cells.

The advantages mentioned for the cell cooling unit and the cooling arrangement according to the invention thus apply similarly to the battery module according to the invention.

Furthermore, the embodiments that were described with regard to a cell cooling unit and a prismatic battery cell also apply analogously to the further cell cooling units of the multiple cell cooling units and the further battery cells of the multiple battery cells.

There is preferably no thermal interface material, such as a thermal paste, a gap filler or a thermally conductive adhesive, between a respective cell cooling unit and the associated battery cell. The battery module, in particular the cell stack with the multiple battery cells and their associated cell cooling units, is preferably clamped in the stacking direction by means of a clamping device. Due to the resulting pressing force between the battery cells, these are also correspondingly pressed against the cell cooling units. This creates very good surface contact between the sides of the battery cells and the corresponding sides of the cooling walls of the cell cooling units. This enables very good heat transfer between the corresponding components, namely between the battery cells and the cell cooling units. By avoiding such interface materials, additional weight and costs can be saved. This also makes it easier for a battery module to be disassembled into its individual components, which has advantages in the event of a repair.

A high voltage battery with one or more battery modules according to the invention or its embodiments and a motor vehicle with one or more battery modules according to the invention or its embodiments should also be regarded as included in the invention.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations that have a respective combination of the features of multiple of the described embodiments, provided that the embodiments have not been described as mutually exclusive.

### BRIEF DESCRIPTION OF THE FIGURES

Exemplary embodiments of the invention are described hereinafter. In particular:

FIG. 1 shows a schematic representation of a prismatic battery cell for a cooling arrangement according to an exemplary embodiment of the invention;

FIG. 2 shows a schematic and perspective illustration of a part of the battery cell of FIG. 1 from a different perspective, according to an exemplary embodiment of the invention;

FIG. 3 shows a schematic illustration of a part of a battery module according to an exemplary embodiment of the invention;

FIG. 4 shows a schematic and perspective illustration of a battery module with U-shaped cell cooling units according to an exemplary embodiment of the invention;

FIG. 5 shows a schematic illustration of view from below of the battery module of FIG. 4 according to an exemplary embodiment of the invention;

FIG. 6 shows a schematic and perspective illustration of a battery module with L-shaped cell cooling units according to an exemplary embodiment of the invention; and

FIG. 7 shows a schematic illustration of a part of the battery module from FIG. 6 from a different perspective, according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

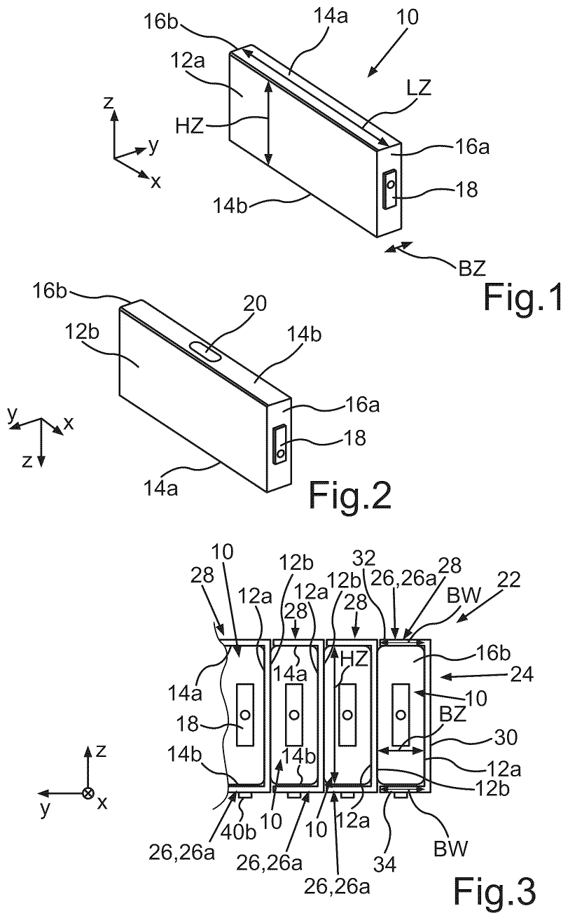

FIG. 1 and FIG. 2 respectively show a schematic and perspective illustration of a battery cell 10 for a cooling arrangement and a battery module according to one exemplary embodiment of the invention. The battery cell 10 is shown in different views. In FIG. 1 the prismatic battery cell 10 is shown in a view obliquely from above and in FIG. 2 in a view obliquely from below in relation to a preferred intended installation position in a motor vehicle. With respect to this intended installation position in a motor vehicle, the z axis of the coordinate system shown here is preferably aligned in the direction of a vehicle vertical axis of the motor vehicle. However, other installation positions are also conceivable.

The prismatic battery cell 10 shown here has a first side 12a, which can be seen in FIG. 1, and a fourth side 12b, which is opposite in the y-direction and can be seen in FIG. 2. The battery cell 10 also includes a second side 14a and a third side 14b that is opposite in the z-direction. Moreover, the battery cell 10 has a fifth side 16a and a side 16b that is opposite with respect to the x direction. In addition, the battery cell 10 includes two cell poles 18, of which only one, namely the one on the fifth side 16a, can be seen in the present illustrations. The other cell pole 18 is located on the opposite sixth side 16b of the battery cell 10. The cell poles 18 are therefore arranged on opposite sides of the battery cell 10. In addition, the battery cell 10 has a releasable cell degassing opening 20, which can be seen in FIG. 2. This can be designed as a predetermined breaking point, for example a bursting membrane. This is preferably located on the third side 14b of the battery cell 10. The first side 12a and the fourth side 12b represent the largest sides of the battery cell 10 in terms of surface area. The battery cell 10 also has a cell width BZ in the y direction, a cell height HZ in the z direction and a cell length LZ in the x direction. The cell width BZ preferably represents the smallest dimension of length LZ, width BZ and height HZ.

To form a battery module 22, as shown schematically partially in a side view according to an exemplary embodiment of the invention in FIG. 3, multiple of these prismatic battery cells 10 can be lined up in a stacking direction that corresponds to the y-direction of the coordinate system shown. The cells 10 are therefore arranged relative to one another in the cell stack 24 of the battery module 22 in such a way that their largest sides 12a, 12b, in terms of surface area, face each other. In particular, except for the edge cells of the cell stack 24, the first side 12a of a respective battery cell 10 thus faces a fourth side 12b of the adjacent battery cell 10, and every fourth side 12b faces a first side 12a of the adjacent cell 10.

A cell cooling unit 26 is now advantageously provided for each cell 10 of this cell stack 24, which comprises the sum of the battery cells 10 arranged next to one another in the y direction. Such a cell cooling unit 26 represents a cooling arrangement 28 in combination with an associated battery cell 10, which is arranged semi-enclosed on this associated cell cooling unit 26. In other words, such a cooling arrangement 28 comprises a cell cooling unit 26 and a battery cell 10 arranged thereon, wherein the cell cooling unit 26 encloses the associated battery cell 10 at least on one side. In the present case, the cell stack 24 is therefore made up of multiple such cooling arrangements 28.

These respective cell cooling units 26 represent liquid cooling systems. In other words, cooling channels or cooling channel portions forming a common cooling channel are integrated into a respective cell cooling unit 26, through which channels a cooling liquid can flow and actually flows during operation. The angled shape of the cell cooling unit 26 also makes it possible to provide multi-sided cooling of a respective prismatic battery cell 10. In the present example, the cell cooling unit 26 is designed as a U-shaped or C-shaped cell cooling unit 26a. This thus lies on the associated battery cell 10 directly on three sides of this battery cell 10. In addition, the illustrated structure and arrangement of these cooling arrangements 28 in the form of a cell stack 24 means that another side of the battery cell 10 can be cooled by the cell cooling unit 26 of the adjacently arranged cooling arrangement 28. This means that four-sided cooling of a respective battery cell 10 can even be achieved. What is particularly advantageous is that the sides of the battery cell 10, which are contacted directly by some of the cell cooling units 26, are at least the sides 12a, 12b with the largest surface area. This makes it possible to provide even more efficient cooling. In particular, this makes it possible to provide the cooling effect compared to previous concepts, according to which, for example, a cell stack is arranged on a cooling plate and thus only provides one-sided cooling of the cells, and not even on one of the largest sides of the cells. In addition, additional elements and components can be omitted, such as cell separating elements, which are usually located between the cells 10, as well as optional thermal interface materials between the cells 10 and the cell cooling units 26. Nevertheless, it is still conceivable that the cells 10, for example at the respectively assigned cell cooling unit, are connected or glued via such a thermal interface material.

The respective cell cooling units 26 can be constructed identically. Therefore, only one cell cooling unit 26 will be described in the following, wherein the following statements can apply analogously to all other cell cooling units 26 of a cell stack 24 or battery module 22. Such a cell cooling unit 26, in particular the C-shaped or U-shaped cell cooling unit 26a shown here, has a first cooling wall 30 which is arranged on the first side 12a of the associated cell 10. In addition, the cell cooling unit 26 includes a second cooling wall 32, which is arranged on the second side 14a of the battery cell 10, and a third cooling wall 34, which is arranged on the third side 14b of the cell 10. The respective cooling walls 30, 32, 34 are designed to be double-walled and comprise integrated cooling channels or cooling channel portions. These cooling channels or cooling channel portions are preferably fluidly connected to one another, so that the number of interfaces for supplying a coolant to the cell cooling unit 26 and for removing the coolant from it can be reduced to a minimum, namely to two. For the supply of a coolant, the cell cooling unit 26 comprises a coolant supply connection 40a (see FIG. 5) and for the discharge of the coolant a coolant discharge connection 40b, both of which are arranged on the third wall 34 in this example, wherein the coolant supply connection 40a in this example is arranged in the x direction behind the discharge connection 40b and is therefore covered by it in the present side view. The cooling walls 30, 32, 34 are also arranged at right angles to one another and are therefore optimally adapted to the geometry of the prismatic battery cell 10 to be accommodated. In particular, the second and third cooling walls 32, 34 each have a wall width that essentially corresponds to the cell width BZ. The wall width BW can also be slightly larger or smaller than the cell width BZ. However, the maximum wall width BW preferably corresponds to at least half of the cell width BZ and is at most as large as, for example, 1.5 times a cell width BZ. The wall width BW is preferably dimensioned such that when the cooling arrangements 28 are arranged as intended in a cell stack 24, as shown in FIG. 3, the cells 10 can come into contact with their fourth side 12b with the first cooling walls 30 of the adjacent cooling arrangement 28. It can be provided that the individual cell cooling units 26 do not touch each other. Alternatively, they can also touch each other and in particular they can also be mechanically connected to one another, for example by clipping. However, a small distance between the cell cooling units 26 in the y direction is advantageous in order to allow a certain tolerance compensation and to ensure that the respective fourth side 12b of a battery cell 10 can also securely come into contact with the first cooling wall 30 of the adjacent cell cooling unit 26. In addition, this can ensure that the cell cooling units 26 are not subjected to excessive stress when the cell stack 24 is clamped in the y direction.

As can also be clearly seen in this illustration, this design of the cell cooling units 26, in particular due to their angled, in this case C-shaped or U-shaped design, also makes it possible to achieve a significantly higher structural rigidity of this cooling arrangement, especially when it comes to force application from the x-direction or in the x-direction. Accordingly, it is conceivable, for example, although not shown here, that the respective cell cooling units 26, in particular all of the cooling walls 30, 32, 34 they comprise, or only some of the cooling walls 30, 32, 34, protrude beyond the cell in question in and/or against the x direction. This offers additional protection for the cell 10, especially for the cell poles 18 arranged on the fifth and sixth sides 16a, 16b.

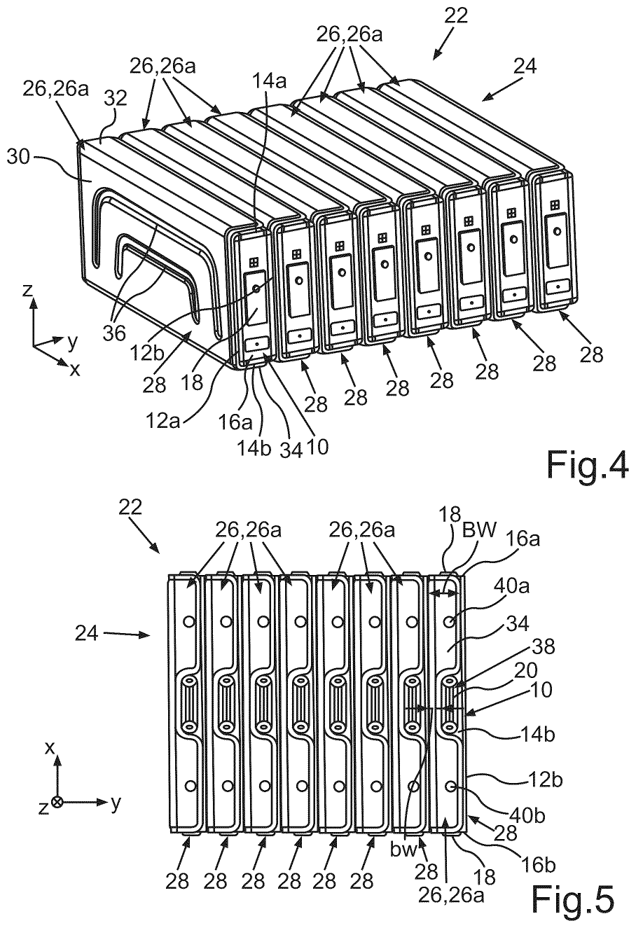

FIG. 4 shows a schematic and perspective illustration of a battery module 22 with C-shaped or U-shaped cell cooling units 26, 26a according to one exemplary embodiment of the invention. In particular, this battery module 22 or the cell stack 24 can be designed in exactly the same way as described above. What can be seen here is, above all, that the first cooling wall 30 of a respective cell cooling unit 26 is preferably designed in such a way that the entire first side 12a of an associated battery cell 10 is covered by it. In addition, the respective second cooling walls 32, which represent those cooling walls 32 which are arranged on the side 14a of the associated cell 10 which does not have a cell degassing opening 20, are preferably designed in such a way that the entire second side 14a of the associated battery cell 10 is also covered by them. The first cooling wall 30 and the second cooling wall 32 therefore have a substantially rectangular base surface area in a direct plan view of the respective cooling wall 30, 32. The contact surfaces of the respective cooling walls 30, 32, 34, against which the corresponding cell sides of the battery cell 10 rest, are also preferably flat, at least for the most part, as are the cell sides of the battery cell 10 itself. With regard to the first cooling wall 30, this is also designed to be as flat as possible, at least for the most part, on its opposite side, facing away from the first side 12a of the cell 10, so that the largest possible contact surface for the adjacent battery cell 10 can also be provided. As can be seen in the present example in FIG. 4, embossings 36 can be provided in the individual cooling walls 30, 32, 34, as shown in this example for the first cooling wall 30. Through such embossings 36, the corresponding cooling channels and flow channels can be formed inside the double-walled cell cooling unit 26. This can ensure a defined flow within the cell cooling units 26. The course of the embossings 36 shown is only illustrative. This can also take a different form.

The fifth and sixth sides 16a, 16b of a respective battery cell 10 are otherwise not covered by the cell cooling unit 26. The cell poles 18 are located on these sides 16a, 16b.

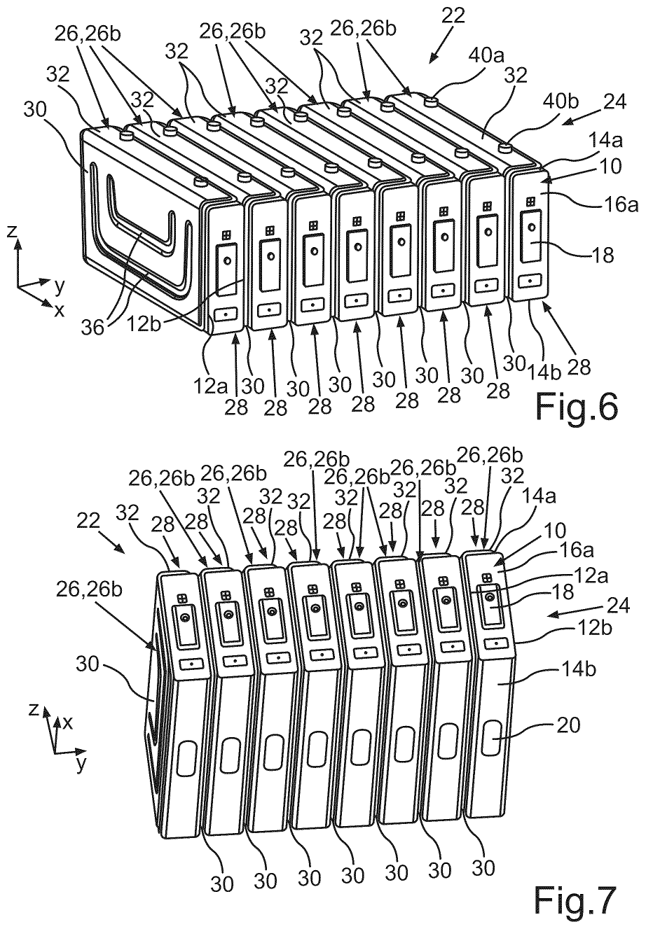

FIG. 5 shows a schematic representation of the battery module 22 from FIG. 4 in a view from below, that is to say of the respective third sides 14b of the battery cells 10. The respective cell degassing openings 20 are provided on these third sides 14b. Accordingly, the respective third cooling walls 34 of the respective cell cooling units 26 are now advantageously designed with a corresponding recess 38. This recess 38 is therefore such that the third cooling wall 34, which rests flatly on the third side 14b of the battery cell 10, does not cover the cell degassing opening 20. In the present case, this is advantageously realized by a reduced wall width bw of the third cooling wall 34. In other words, the wall width bw in the region of this recess 38 in the y direction is smaller than a maximum wall width BW in the remaining regions of the third cooling wall 34. Also visible in this illustration are the opposite cell poles 18, of which one is arranged on the fifth side 16a and one on the sixth side 16b of the battery cell 10, and per cell cooling unit 26 a coolant supply connection 40a and a coolant discharge connection 40b, via which a coolant can be supplied to the cell cooling unit 26 and removed from it again. The positions of the coolant supply connection 40a and the coolant discharge connection 40b may also be reversed. In addition, these connections 40a, 40b do not have to be both arranged on the third cooling wall 34, but one or both of them can alternatively be arranged on the opposite second cooling wall 32, for example as in the example shown in FIG. 6. Theoretically, an arrangement on an edge region of the first cooling wall 30 that protrudes in or against the x direction is also conceivable. However, this is less preferred.

FIG. 6 shows a schematic representation of a battery module 22 according to a further exemplary embodiment of the invention. In particular, this battery module 22 or the cooling arrangements 28 comprised by it can be designed as described above, except for the following differences: these relate in particular only to the design of the cell cooling units 26, which in this example are not C-shaped or U-shaped, but L-shaped and are correspondingly designated 26b. In order to provide such an L-shaped cell cooling unit 26, the additional third cooling wall 34 was omitted in this example. Accordingly, in this example, no part of the cell cooling unit 26b is arranged on the third sides 14b. FIG. 7 shows the battery module 22 from FIG. 6 again in a perspective view from a different perspective, in particular from obliquely below, so that the exposed third sides 14b of the respective cells 10 can be seen. Alternatively, to provide such an L-shaped cell cooling unit 26, the second cooling wall 32 could also be dispensed with instead of the third cooling wall 34. Then the respective second sides 14a of the battery cells 10 would be exposed.

In order to still cool these exposed sides, such as the third sides 14b of the cells 10 in this example, it is also conceivable to position the cell stack 24, for example with the respective third sides 14b of the cells 10, on a cooling plate, so that accordingly the third sides 14b face this cooling plate. Such a cooling plate can, for example, be provided at the same time by a housing base of a battery housing. In this example, the coolant supply and discharge connections 40a, 40b are also arranged on the second cooling wall 32 instead of on the third cooling wall 34 as previously described.

Overall, the examples show how the invention can provide an enclosure for the cell cooling elements. Through the three-dimensional design of a cell-specific cooling element, which is provided by the cell cooling unit, the connected cooling surface of a cell, in particular a prismatic battery cell, can be maximized. According to previous cooling concepts, the cooling of prismatic battery cells of a battery system usually takes place via a cooling plate at the top and/or bottom, which is fixed to the module or is part of the overall system. So far, only a small proportion of the actual total cell surface area could be connected directly to such a cooling system. The invention thus advantageously enables an enormous increase in the cooled cell surface area, in particular the directly cooled cell surface area. In this case, the battery cell is cooled via a cooling element surrounding the cell. This contacts at least two surfaces of a cell that are at right angles, for example if it is designed as an L-shaped cooler, or in a further embodiment, three surfaces of a cell can also be cooled if the cooling element is designed as a U-shaped cooler. By lining them up in the system, the bottom surface, top surface and both side surfaces can be cooled at the same time. This means that the entire surface area of a prismatic cell is connected to the cooling system, in particular with the exception of the sides with the cell poles. The emergency degassing element of the cell, namely the releasable cell degassing opening, can be omitted due to the design of the cooler. In addition, the cooling plates can be formed by ribs, which were previously referred to as embossings, so that the cooling medium, in particular the cooling liquid, is distributed to the different portions of the cooler, as required, and the cell is cooled homogeneously from all sides. Due to the design as an L or U-shaped cooler, the cooler itself can absorb very high forces, as the design prevents buckling. Depending on the orientation of the cell in the assembled component, this enables the system to absorb longitudinal or transverse forces in the event of a crash.

1. A cell cooling unit for multi-sided cooling of a prismatic battery cell of a battery module, comprising:
a first cooling wall for arrangement on a first side of the prismatic battery cell, and
a second cooling wall for arrangement on a second side of the battery cell,
wherein the second cooling wall connects to the first cooling wall at right angles,
wherein the first cooling wall has at least one first cooling channel portion through which a liquid coolant can flow, and the second cooling wall has at least one second cooling channel portion through which a liquid coolant can flow.

2. The cell cooling unit according to claim 1, wherein the at least one first cooling channel portion and the at least one second cooling channel portion are fluidly connected to one another.

3. The cell cooling unit according to claim 1, wherein the cell cooling unit has a third cooling wall for arrangement on a third side of the battery cell, wherein the third cooling wall perpendicularly connects to the first cooling wall and lies opposite the second cooling wall, in particular wherein the third cooling wall has at least a third cooling channel portion which is fluidly connected to the first cooling channel portion.

4. The cell cooling unit according to claim 1, wherein the second cooling wall has a recess for a cell degassing opening of the battery cell, wherein the second cooling wall has a wall width in a first direction and a wall length in a second direction, wherein the wall width varies along the second direction and is smaller in the region of the recess for the cell degassing opening compared to a maximum wall width of the second cooling wall in the first direction.

5. The cell cooling unit according to claim 1, wherein the cell cooling unit has a coolant supply connection and a coolant discharge connection, which are arranged on the second and/or third cooling wall.

6. A cooling arrangement with a cell cooling unit according to claim 1,
the cooling arrangement comprises the prismatic battery cell,
which has a cell width in a first direction, a cell length in a second direction and a cell height in a third direction, which has the first side and an opposite fourth side, which delimit the battery cell in the first direction and which represent the two largest sides of the battery cell in terms of surface area,
which has a fifth side and an opposite sixth side which delimit the battery cell with respect to the second direction, and
which has the second side and the third side, which delimit the battery cell with respect to the third direction,
wherein the maximum wall width of the second cooling wall and/or the third cooling wall corresponds to the cell width or is smaller.

7. The cooling arrangement according to claim 6, wherein the battery cell has two cell poles which are arranged on the fifth and/or sixth side of the battery cell, in particular one of which is arranged on the fifth side and one on the sixth side.

8. The cooling arrangement according to claim 6, wherein the first cooling wall protrudes in the second direction at least beyond one of the fifth and sixth sides of the battery cell.

9. The cooling arrangement according to claim 6, wherein the battery cell has a releasable cell degassing opening, in particular in the form of a predetermined breaking point, on the second side or on the third side.

10. A battery module for a motor vehicle, with multiple prismatic battery cells which are arranged next to one another in the first direction, wherein each of the battery cells is assigned a cell cooling unit according to claim 1, which is arranged on the associated battery cell, so that the first cooling wall of at least one of the cell cooling units is located between two battery cells arranged adjacent to one another and rests in particular on both of these battery cells.

11. The cell cooling unit according to claim 2, wherein the cell cooling unit has a third cooling wall for arrangement on a third side of the battery cell, wherein the third cooling wall perpendicularly connects to the first cooling wall and lies opposite the second cooling wall, in particular wherein the third cooling wall has at least a third cooling channel portion which is fluidly connected to the first cooling channel portion.

12. The cell cooling unit according to claim 2, wherein the second cooling wall has a recess for a cell degassing opening of the battery cell, wherein the second cooling wall has a wall width in a first direction and a wall length in a second direction, wherein the wall width varies along the second direction and is smaller in the region of the recess for the cell degassing opening compared to a maximum wall width of the second cooling wall in the first direction.

13. The cell cooling unit according to claim 3, wherein the second cooling wall has a recess for a cell degassing opening of the battery cell, wherein the second cooling wall has a wall width in a first direction and a wall length in a second direction, wherein the wall width varies along the second direction and is smaller in the region of the recess for the cell degassing opening compared to a maximum wall width of the second cooling wall in the first direction.

14. The cell cooling unit according to claim 2, wherein the cell cooling unit has a coolant supply connection and a coolant discharge connection, which are arranged on the second and/or third cooling wall.

15. The cell cooling unit according to claim 3, wherein the cell cooling unit has a coolant supply connection and a coolant discharge connection, which are arranged on the second and/or third cooling wall.

16. The cell cooling unit according to claim 4, wherein the cell cooling unit has a coolant supply connection and a coolant discharge connection, which are arranged on the second and/or third cooling wall.

17. The cooling arrangement according to claim 7, wherein the first cooling wall protrudes in the second direction at least beyond one of the fifth and sixth sides of the battery cell.

18. The cooling arrangement according to claim 7, wherein the battery cell has a releasable cell degassing opening, in particular in the form of a predetermined breaking point, on the second side or on the third side.

19. The cooling arrangement according to claim 8, wherein the battery cell has a releasable cell degassing opening, in particular in the form of a predetermined breaking point, on the second side or on the third side.
